(19) United States
(12) Patent Application Publication
(10) Pub. No.: US 2015/0375559 A1
(43) Pub. Date: Dec. 31, 2015

(54) Story Sticks and Methods of Making and Using the Same

(71) Applicant: Marc Iverson, Salt Lake City, UT (US)

(72) Inventor: Marc Iverson, Salt Lake City, UT (US)

(21) Appl. No.: 14/314,166

(22) Filed: Jun. 25, 2014

(51) Int. Cl. B43K 19/16

(52) U.S. Cl. CPC B43K 19/16

(57) ABSTRACT

Embodiments are described herein that provide recitation assistance devices and methods of using them. Such methods may include the steps of providing at least one hand-held physical media, and marking the at least one physical media with a clear sequence of letters, each letter representing a word such that the sequence is the first letters of a series of words imparting a particular meaning. In some embodiments, the physical media may include wood, such as a pencil or dowel. Similarly, in some embodiments, the marking the physical media may include marking the sequence of letters on the facets of the pencil, such as creating a spiral pattern around the physical media where the sequence of letters proceeds along the spiral pattern, such that the physical media is rotated to present the sequence of letters in order.

### FIELD

This application relates generally to entertainment and educational devices. In particular, this application relates to physical media with abbreviated markings representing a text and methods of making and using the physical media and markings.

### BACKGROUND

Story telling is as old as human communication. Long before literacy, humans passed stories down from one generation to the next as a way to entertain, preserve family history, instill morality, and encourage social norms. Today, story telling happens in a variety of media. However, a single person telling a story still has the power to captivate individuals and audiences. Some stories are very powerfully written, such that presenting the story as written strengthens the impact. And in some cases, such as plays, songs, and movies, the exact repetition of a text is very important. The common way to remember specific text is to refer to a book or other paper with the words printed on it. However, paper can be bulky, cumbersome, and can certainly detract from performance of a story, poem, play, song, etc.

The most primative tribes of history have been known to require ceremonial objects for preservation of values and usually an amount of history, through most often for preservation of names or the deeds of valor accomplished by their leaders. If a citizen could remember such facts better for keeping or inheriting a venerated relic featuring glyphs or language characters, men would only think it pleasing to their traditional gods or departed ancestors.

Although “civilized” people have less interest in connecting their mystic past to circumstances of the present, younger humans today are often quick to share in drama or re-enactments of classic lore, as to revive the legend of pilgrims meeting American natives at a feast of good will. Also, young children will sometimes cling to an aging garment or blanket, probably as much because it represents past nervous and emotional investment as for continued support. Unfortunately, when told to stand (or in the bathroom, sit) on their own, youngsters perceive little more from their immature companions than examples of popular enthusiasm, as though possession and conformity greatly outweigh investment and choice. Few older children and adults modify or customize their material possessions except to demonstrate prowess, making a constantly refined smart phone somewhat analogous to a polished and feathered spear for a native.

What is therefore needed is a “story stick” as described below in this document, which is capable of joining with high-tech toys and games of popular prowess, and could as well become a symbol of maturity or social ambition if its keeper wishes to prove a readiness to share from its store of history or art.

### SUMMARY

Accordingly, embodiments are described herein that provide a method of making a recitation assistance device. The method may include the steps of providing at least one hand-held physical media, and marking the at least one physical media with a clear sequence of letters, each letter representing a word such that the sequence is the first letters of a series of words imparting a particular meaning. In some embodiments, the physical media may include wood, such as a pencil or dowel. Similarly, in some embodiments, the marking the physical media may include marking the sequence of letters on the facets of the pencil, such as creating a spiral pattern around the physical media where the sequence of letters proceeds along the spiral pattern, such that the physical media is rotated to present the sequence of letters in order.

The at least one hand-held physical media may include several sequentially organized physical media, wherein each of the several sequentially organized physical media is marked such that the markings represent a single literary work. The at least one physical media may be arranged in a media holder. The media holder may be a scroll formed using at least one of: fabric, weaving, reeds, and plastic.

### BRIEF DESCRIPTION OF THE DRAWINGS

The following description can be better understood in light of Figures, in which:

FIG. 1a is a side view of an exemplary embodiment of a story stick;

FIG. 1b is a bottom view of the story stick of FIG. 1a;

FIG. 2 is a side view of an exemplary embodiment of a story stick;

FIG. 3 shows an exemplary embodiment of story sticks; and

FIG. 4 shows an exemplary embodiment of story sticks and a carrier is an

Together with the following description, the Figures demonstrate and explain the principles of story sticks and methods of making and using the same. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses on marked pencils and dowels, embodiments and methods may be used with walking sticks, wicker baskets with removable pieces, and other hand-held objects.

A story stick is a “magical” toy that enables one “in the know”—whether adult or child—to recite a story from memory with minimal assistance from letters marked on a hand-held object such as a stick, pencil, etc. A story stick may provide the first letters of each word in a story, poem, lyric, etc. marked on a pencil, band, stick, or other suitable object which could ether be curved circular, or straight in form. The letters may be marked in various patterns on the story stick to provide a user the ability to follow along in either a logical manner or in a way that suits his own preferences or objectives in cases where a “user” himself encodes on the stick or other medium. For example, in some embodiments, the letters may be marked on the facets of a pencil. The order may be provided in several ways.

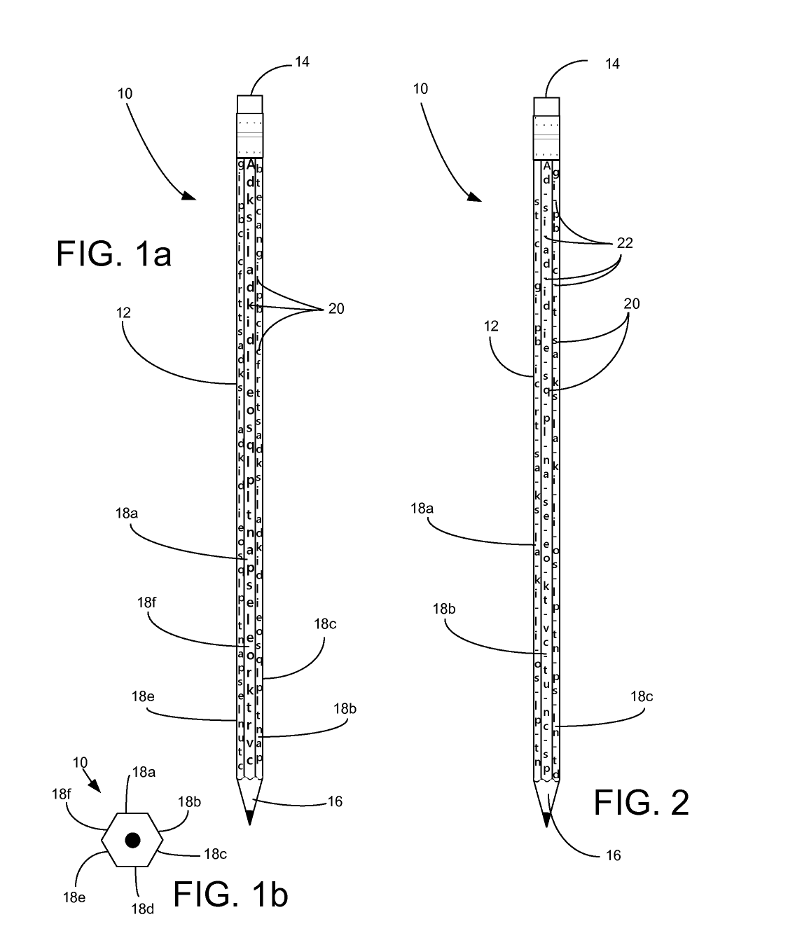

Turning now to the figures, FIGS. 1a-1b illustrate one embodiment of a story stick 10, where the letters may start on a first facet 18a adjacent to the eraser 14 and continue along the length of the body 12 of a pencil toward the sharpened end 16. A user may place a thumb under the letter 20 being read, covering the subsequent letters 20 to avoid confusion and keep the place. The pencil may then be moved upward in the hand, uncovering subsequent letters 20 for reading. At the sharpened end 16, the pencil may be rotated to the next facet 18b where the story continues.

Although the original labels happen most often to have been printed cross-wise, it may be convenient and aesthetically pleasing to write the later letters below the first with the letter oriented with their tops toward the eraser end of the pencil, so that the reader (or inscriber) holds the pencil vertically from the eraser held at its top 14, which may allow a user to use the pencil as a writing instrument while reciting the story. Otherwise, the text would appear a one gigantic word, discouraging the reader from always remembering one's place, which instead can be maintained by covering the upcoming (though continuing downwards,) letters with a thumb.

In other embodiments, the letters 20 may be applied such that the user begins at the sharpened (or non-eraser in the case of an unsharpened pencil) end 16. A user may cover subsequent letters until only the eraser portion 14 is held. The user may then rotate the pencil to the next facet 18b and start at the next column on the adjacent facet 18b, and continue until each subsequent facet 18c, 18d, 18e, 18f is read. In such embodiments, the entire wood portion or body 12 of the pencil may be used since a user may hold an unsharpened pencil by the eraser to reveal each facet of the pencil as it is rotated.

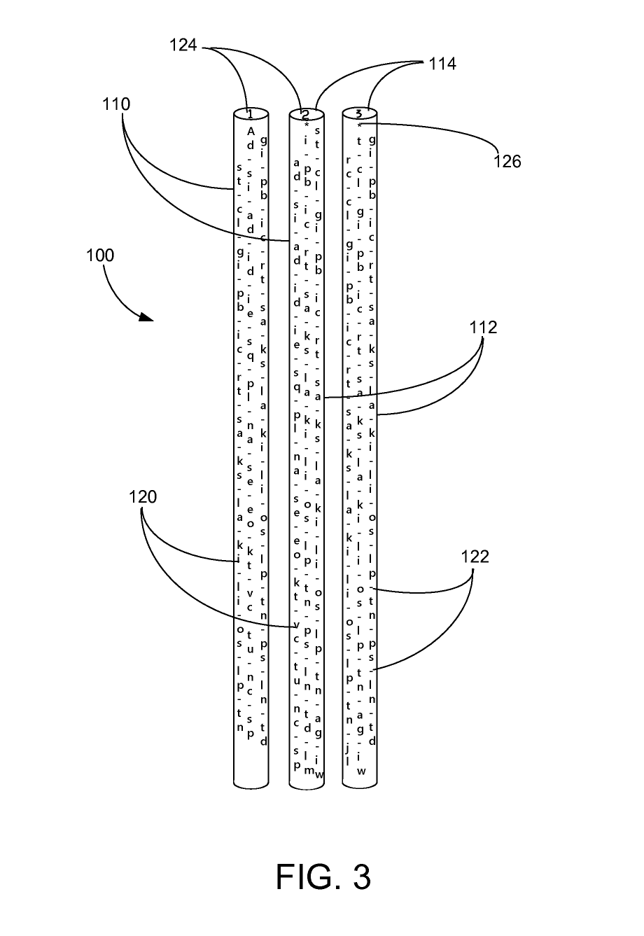

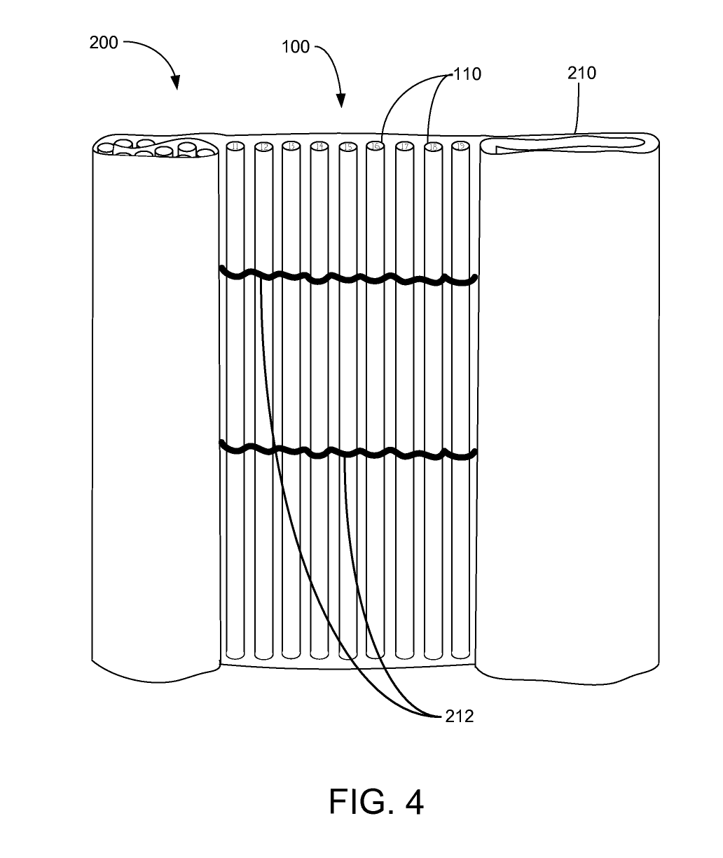

In another embodiment, such as is shown in FIG. 2, the order of the letters 20 may start from the eraser end 14 with subsequent words represented by a letter 20 marked on an adjacent facet 18a-f and slightly descending toward the sharpened end 16 such that by rotating the pencil, the first letter of each word appears in order in a spiral or staircase pattern along the length of the pencil. The letters 20 may be marked on each facet with the tops of the letters towards the eraser end. In some embodiments, two or three letters indicating subsequent words may be marked on one facet with the subsequent two or three letters being marked on the adjacent facet, requiring less rotation. In such embodiments, a dot or other symbol 22 may separate the two or three letter group from groups above or below on that facet. Similarly, when using a round stick as a story stick 110 (FIGS. 3 and 4) (such as a dowel 110, stick from a tree, drumstick, etc.), guide markings 122, (lines, dashes, dots, etc.) may be provided to channel the marked letters 120 in an orderly and logical manner. Such embodiments provide a striped pattern along the story stick, which may be very desirable.

In some embodiments using dowels 110, larger sticks, or other similar objects without facets (such as facets on a pencil), the letters 120 may be presented in a zig-zag pattern separated or distinguished by dots or other symbols, or may be differentiated by different colors. For example, one zig-zag line may be encoded in one color with an adjacent zig-zag line of encoding in another, which may form an aesthetically pleasing pattern, but which also allows for an indication of the sequence by following a particular color while ignoring adjacent letters in a different color. Aesthetically pleasing patterns may also provide the appearance of strength or may otherwise provide additional interest in story sticks and help new users become confident and comfortable in selecting and using the story sticks.

The letters may be marked on the story stick with a fine-tipped marker, may be printed on, or marked using any suitable method. In some embodiments, the letters may be upper or lower case, and sentences, paragraphs, chapters, etc. may be separated by various symbols such as dots, stars, plus signs, etc. Because of the emphasis on environmental friendliness in the present economy, story stick base materials may be obtained which feature natural, unpainted wood. For example, with a pencil, the only preparation necessary is to scrape the labeling (usually the brand and pencil grade) off with a sharp-straight blade such as a razor knife. At least 50 characters can fit on a pencil facet of the usual length, and 325 on the entire pencil.

The title of the story, song, poem, etc. for a particular story stick may be written out, though perhaps somewhat abbreviated, on a portion of the story stick also indicating the beginning of the letters. For example, a pencil facet which had been cleared of the pencil's logo or trademark may be an ideal starting point.

A colorful idea is to consistently print in a variety of hues so as to indicate the length of the word for that letter. For instance, three-letter words might be indicated by a letter in blue, four-letter words in green, and five-letter words in orange, etc. Since it is difficult to distinguish between the darker hues, a limited number of differentiable hues (between 3 and 10), may be used to color the letters, with the longer words all have the same color.

The typical adult or mature child often has a great ability to accurately recall a story text using various methods. This simple and straightforward encoding system will allow most readers and story tellers to easily remember the specific words of a story encoded on a story stick. For some individuals, fewer different colors may be used in various combinations and representing various features of the words they represent. For example, words between one and three letters may be in purple, words between three and five letters may be in red, and words having over five may be in black. Similarly, nouns may be blue, verbs red, adjectives green, etc., or other combinations and indications using color.

In other embodiments, colors may also be used to indicate when a letter refers to more than one word. For example, a character name, such as Tom Sawyer, may be represented with a single “T” or “S” in blue to indicate that it represents the whole name. Similarly, common words such as “the”, “an”, “and”, etc., may be omitted and represented with particular color for the subsequent letter. In such embodiments, “the road” may be encoded with a green “R”. Similarly, as with regular writing, capital and lower case letters may be used to differentiate between words beginning a sentence, proper nouns, etc.

In some embodiments, blank story sticks may be provided with guides printed or engraved on the stick so an individual can mark the story stick with a personal or preferred text. For example, a musician may want to write the lyrics to a song on a drumstick. A drumstick having a spiral pattern of lines and a space for the title of the song may be provided. Similarly, pencils, or other sticks having guide patterns for letters may be provided without the letters.

Story sticks may be provided with the fully-written text represented by the abbreviations on the story stick, or may just indicate which available text is represented. For example, a series of story sticks may accompany an Edgar Allen Poe collection of short stories to enable story tellers to easily recite the well-loved scary stories.

Similarly, as shown in FIGS. 3 and 4, story sticks 110 may be provided in sequenced group 100 for a story stick novel, short story, or any work requiring more than one individual story stick 110. The story sticks 110 for a novel may be numbered 124 on an end, such as end 114, and arranged as the sides to a basket, in a fabric scroll 200, or in a box similar to a crayon box, or other suitable organizing methods. In some embodiments, a covering 200 for the novel may be fashioned with pockets 212 where the story sticks 110 may be positioned. Such devices may not only allow a user to organize and display sticks 110 with particular patterns or favorite passages visible, and others obscured. Additionally, such organization methods may be selected to compliment the theme of the story. For example, a fish or boat pattern may emerge when the sticks are arranged a certain way.

In other embodiments, a particular story stick may include different texts using the same letters. This may be known as “spining”. Spining provides that a particular order of letters may be used for more than one text. For example, the letters MHALL may represent “Mary had a little lamb” or “Memory has a long life.” Such embodiments may encourage users to come up with various creative alternates to the particular order of letters. In some instances, a whimsical phrase may be a spining of an austere quote or text, providing entertainment to the reader and any audience.

In other embodiments, users may create new stories, or may engage in a game of trying to create new stories of phrases to match the letters in various orders on the story stick. For example, if the story stick follows a poem in a spiral pattern around a pencil, users may take turns trying to come up with phrases or stories from the letters that appear on a single facet or only two adjacent facets in some order, etc.

In some embodiments, story sticks may be used to aid in learning to read, memorize, and understand language. In particular, story sticks may be particularly suited to certain learning disabilities. For example, some forms of autism require that the individual concentrate on a particular stimulus to adequately communicate with others. It may well be that focusing on the story stick and the coded text may provide a method for following along in a story, or learning the story. Similarly, it may help indirectly with dyslexia by encouraging memorization of whole words, as may be done to learn around dyslexia.

As will be apparent to those skilled in the art in which the invention is addressed, the present invention may be embodied in forms other than those specifically disclosed above without departing from the spirit or potential characteristics of the invention. Particular embodiments of the present invention described above are therefore to be considered in all respects as illustrative and not restrictive. The scope of the present invention is as set forth in the appended claims and equivalents thereof rather than being limited to the examples and embodiments contained in the foregoing description.

What is claimed is:

1. A method of making a recitation assistance device, comprising:
providing at least one hand-held physical media;
marking the at least one physical media with a clear sequence of letters, each letter representing a word such that the sequence is the first letters of a series of words imparting a particular meaning.

2. The method of claim 1, wherein the physical media includes wood.

3. The method of claim 2, wherein the physical media is a pencil.

4. The recitation device of claim 3, wherein the marking the physical media includes marking the sequence of letters on the facets of the pencil.

5. The method of claim 1, wherein the marking the physical media includes creating a spiral pattern around the physical media.

6. The method of claim 5, wherein the sequence of letters proceeds along the spiral pattern, such that the physical media is rotated to present the sequence of letters in order.

7. The method of claim 1, wherein the at least one hand-held physical media includes several sequentially organized physical media, wherein each of the several sequentially organized physical media is marked such that the markings represent a single literary work.

8. The method of claim 7, wherein the at least one physical media is arranged in a media holder.

9. The method of claim 8, wherein the media holder is a scroll.

10. The method of claim 9, wherein the scroll is formed using at least one of: fabric, weaving, reeds, and plastic.
